(19) United States
(12) Patent Application Publication
(10) Pub. No.: US 2007/0075975 A1
(43) Pub. Date: Apr. 5, 2007

(54) Lap shade

(76) Inventor: Humberto G. Aguilera, Issaquah, WA (US)

Correspondence Address: Humberto G. Aguilera, 22500 56th St. S.E. #9-101, Issaquah, WA, 98029, US

(21) Appl. No.: 11/243,420

(22) Filed: Oct. 5, 2005

(51) Int. Cl. G09G 5/00

(52) U.S. Cl. 345/169

(57) ABSTRACT

The Lap Shade provides fun and essential device for business people and students. The Lap Shade will expand your limitations where you can operate and enjoy your portable lap top computers, notebook computers, portable DVD players and such like portable computers and players outdoors, and view your screens clearly where the sun shines instead of being confined to the indoors because of the sun shinning on the screens. It's easy to attach to the computers or players and easy to fold and it's compact. The Lap Shade is also used to give you privacy as you work on your desk top computers or portable computers and portable DVDs from those that stand or sit next to you trying to view your screens as you work inside, outside, coffee shops and other locations. The Lap Shade can become a testing booth for desk tops or portable computers for companies and schools.

“The Lap Shade” is so that you can view your portable Laptop computers, portable DVD players or other such like portable computers and player and portable computer games with ease while you are operating it outside where the sun shines. Without the “Lap Shade”, the screens would be hard to view because of the glare of the sun light that darkens the screens and limits your location which you can only use your portable computers or DVD players or other such like portable computers or players and portable computer games.

“The Lap Shade” is also used for the purpose of giving the user the privacy that he/she needs when operating their portable computer, portable DVD player or desk top computer with the flat computer screen, or other such like computers and players in public. When working on personal documents or viewing secret documents or creating a new design or invention and you just don't want anyone who is sitting or standing next to you or near you and you want privacy, especially in a class room setting, “The Lap shade” will give you just that, privacy.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This invention relates to portable computer lap tops, computer notebooks and portable DVD players and other such like portable computers and players and portable computer games and to enhance the use of these portable computers and players including the desk top computers with the computer flat screens.

Department stores, electronic departments, computer stores and computer companies supply customers with computers and other accessories.

The information known to me by my own searching efforts, including references to specific documents which relates to my invention is not found.

These portable computers and portable DVD players and other such like portable computers and players and portable computer games, only have a limited usage for the consumer in regards to the locations that they may operate the portable computers and players. The Sunny days and even under the shady trees can hinder the usage and limit the operation of these portable computers and players by the user.

When you do use the portable computers, note book computers and portable DVD player, and desk top computers with the computer flat screens and other such like computers and players indoors, you don't have the privacy to view it by yourself when someone is sitting or standing next to you.

### BRIEF SUMMARY OF THE INVENTION

Accordingly, besides the objects and advantages of the portable computers and portable DVD player and desk top computers with the flat screens described in my above patent; several objects and advantages of the present invention are:
a. To provide a Lap Shade that can be fun for all ages.
b. To provide a Lap Shade that can be useful to expand the use of portable computers and DVD players out doors and to give you the privacy you need indoors as well as the privacy you need when operating them outdoors.
c. To provide a Lap Shade that will take the inside work to enjoy doing it outside in the park, beach, lake, college campus outside tables, outside your patio and other such like locations.
d. To provide a Lap Shade that will give you the privacy you need when operating your portable computers when sitting in the coffee shop, cafeteria, the work place, work break room, or any where you see that you need the privacy.
e. To provide a Lap Shade that will give you the privacy you need when operating your desk top computer with flat screens as you are taking a test or an exam in your computer program classes, or other classes from English to whatever class are giving the tests or exams.
f. To provide a Lap Shade that a business or company can sit an individual to fill out the forms the company demands for you to complete with privacy.
g. To provide a Lap Shade that a business or company can sit an individual to take a company given test on a Portable computer or other such like portable computers.
h. To provide a Lap Shade that folds for easy storage and is compact for your computer brief case.
i. To provide an accessory that will not limit you on your portable computer or portable DVD player usage or other such like portable computers and players and portable computer games.

### BRIEF DESCRIPION OF THE SEVERAL VIEWS OF THE DRAWING

In the drawings, closely related figures have the same number.

FIG. 1A is a perspective view of the Front of the Lap Shade.

FIG. 1B is a perspective view of the Front of the Lap Shade.

FIG. 2A is a perspective view of the Side of the Lap Shade.

FIG. 2B is a perspective view of the Easy Fold of the Lap Shade.

FIG. 3 is a perspective view of the Top of the Lap Shade.

FIG. 4 is a perspective view of the Back of the Lap Shade.

FIG. 5 is a perspective-view of the Peek Hole Attachment of the Lap Shade.

Reference: Numbers in Drawings
10) Cloth Material Curtain 20) Swivel Rod
12) Folding Seam 22) Velcro Belt
14) Thin and Light Plastic or Metal 24) Peek Hole
16) Thin and Light Plastic or Metal 26) Velcro Strip
18) Velcro Strip

### DETAILED DESCRIPTION OF THE INVENTION

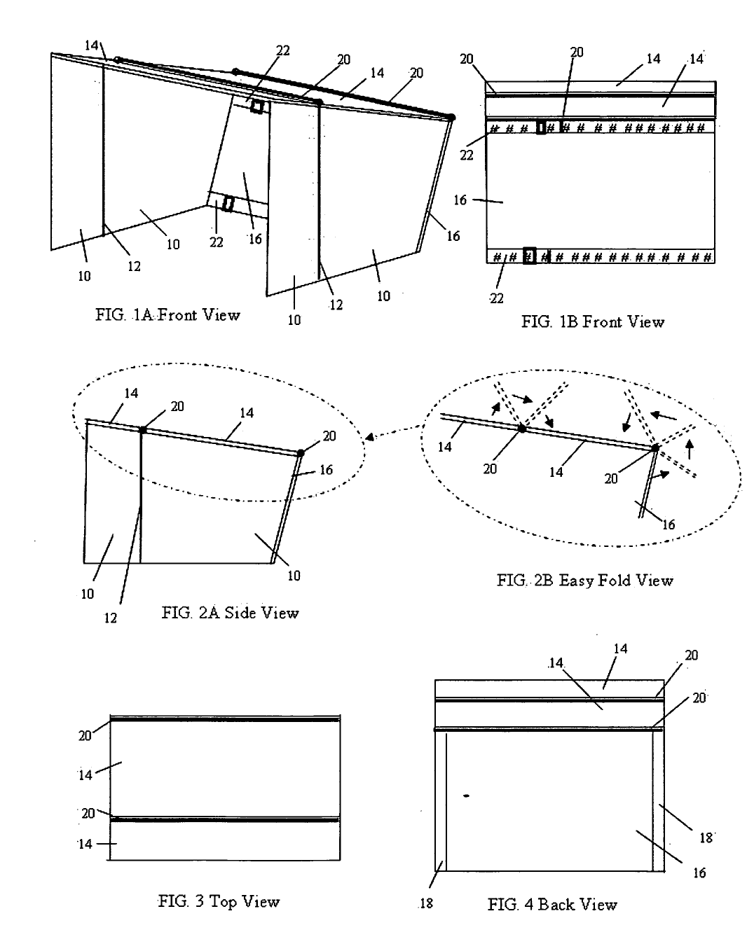

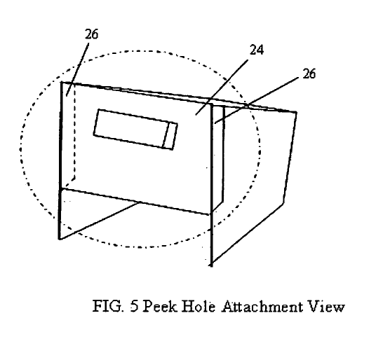

A typical embodiment of the Lap Shade of the present invention is illustrated in FIG. 1 (Front View), FIG. 1B (Front View), FIG. 2A (Side View), FIG. 2B (Folding Function), FIG. 3 (Top View), FIG. 4 (Back View) and FIG. 5 (Peek Hole Attachment View).

The Lap Shade (see FIG. 1A) (see FIG. 1B) has two separate velcro belt straps (22) which slips over the portable computer screen or portable DVD screen or other such like portable computers and players and portable computer games. The two velcro belt straps (22) are then tightened to secure and fasten the Lap Shape to the portable computers or portable DVD players or other such like portable computers or players and portable computer games. The top of The Lap Shade (see FIG. 2A) is then unfolded (see FIG. 2B) and extended into place.

The back (16) (see FIG. 4) (see FIG. 1A) (see FIG. 1B) (see FIG. 2A;) of the Lap Shade is made of a thin, light weight, firm and unbendable plastic, metal or other such like material. The velcro belt straps (22) are fastened to the front of the back side (16) (see FIG. 1).

The top (14) (see FIG. 3) (see FIG. 2A) (FIG. 2B) of the Lap Shade is made of the same material as of the back (16) (see FIG. 4) of the Lap Shade.

The top (14) (see FIG. 3) (see FIG. 2A) (see FIG. 1A) (see FIG. 4) is a two piece top, which is connected together with a swivel thin rod (20) and another swivel thin rod (20) that connects the top (14) to the back (16) of the Lap Shade. The swivel thin rods (20) (see FIG. 2A) (See FIG. 2B) are for the purpose to easily fold or unfold the Lap Shade and to make it compact and convenient for the consumer.

The sides (10) (see FIG. 2A) (see FIG. 1A) are made out of cloth type curtain materials (10) such as blackout lining or other such like materials, which are connected to the side edges of the top (14) (see FIG. 2A) (see FIG. 1) and hangs down to the sides of the base of the portable computers or DVD players or other such like portable computers and players or portable computer games.

The sides (10) (see FIG. 2A) (see FIG. 1A) of the Lap Shade has a seam (12) on both sides of The Lap Shade for easy fold when the top (14) with the thin swivel rods (20) (see FIG. 2A) (FIG. 2B) are unfolded or folded for easy storage.

The back (see FIG. 4) of The Lap Shade has a velcro strip (18) on each side of the back to connect to the back edges of the cloth type sides (10), to seal out the outside light.

The Peek Hole Attachment (24) (see FIG. 5) attaches to the front of The Lap Shade to give that extra added shade. On each side of the peek hole attachment, it has a Velcro strip (26) that can be fastened to the side curtains (10) of The Lap Shade.

What I claim as my invention is “The Lap Shade”.

1. Running your portable computer or player on batteries will not lighten up the viewing screen as strong as if you were to plug it to an electrical outlet that would cause your computer screens to excessively to light up.
Running your portable computers and DVD players and other such like portable computers and player and portable computer games on batteries will cause a very dim viewing screen on your portables and when the sun shines on it, it worsens the viewing capabilities.
The Lap Shade can be used to expand your limitations of locations where you can operate and enjoy your portable lap top computer, notebook computer, portable DVD players and other such like portable computers and players and portable computer games outdoors where the sun shines instead of being confined to the indoors for visibilities.
Thus the reader will see The Lap Shade of the invention provides, economical, fun and essential device that can be used by persons of almost any age.
It permits you to see the portable computer's or portable DVD's screens or other such like portable computers or player or portable computer games as you are enjoying the outdoors.
It provides portable shade to your portable computer, notebook computer, and portable DVD player or other like such portable computers or player or portable computer games to every sunny locations you desire to go.
It provides privacy as you use your portable lap computers and DVD players and other such like computers and players as you are operating them indoors or outdoors when you are amongst the crowd or one standing near you or sitting next to one who wants to peek at what you are doing or working on.
It provides privacy to those who are taking an exam, or a test or just filling out personal data for the company on a portable lap top computer or desk top computer with a flat computer screen.
It provides the production of The Lap Shade base (base is the top and the back of the Lap shade (see FIG. 3) (see FIG. 4)) to come in plastic, metal, aluminum or other such like materials and in a variety of colors designs and art work.
It provides the production of The Lap Shade cloth material sides (10) (see FIG. 1A) (see FIG. 2A) to be interchangeable and come in a variety of colors, prints, drawings, art work, fabrics and materials and sizes.
It provides the production of The Lap Shade in a variety of shapes and styles.
It provides the production of The Lap Shade to come in a variety of sizes to meet the consumers demand.
The Lap Shade is unique, portable, compact and easy to store.
The Lap Shade is essential to the business man, student, and to everyone that owns a portable computer, notebook computer, portable DVD player and other such like computers and players and portable computer games.
The elements may be rearranged differently or different element functions may be added to The Lap Shade.
